(19) United States
(12) Patent Application Publication
(10) Pub. No.: US 2023/0337596 A1
(43) Pub. Date: Oct. 26, 2023

(54) MULCH FILM LAYING ROBOT AND MULCH FILM LAYING METHOD

(71) Applicant: QILU UNIVERSITY OF TECHNOLOGY, Jinan City (CN)

(72) Inventors: FENGYING MA, JINAN CITY (CN); YUHE SUN, JINAN CITY (CN); PENG JI, JINAN CITY (CN)

(21) Appl. No.: 18/193,609

(22) Filed: Mar. 30, 2023

(30) Foreign Application Priority Data
Apr. 22, 2022 (CN) 202210425700X

(51) Int. Cl. A01G 13/02

(52) U.S. Cl. CPC A01G 13/0287; A01G 13/0275

(57) ABSTRACT

The present disclosure relates to a mulch film laying robot and a mulch film laying method. The mulch film laying robot comprises a walking mechanism for walking, a mulch film laying mechanism for mulch film laying, a mulch film compaction mechanism for compacting a laid mulch film, and a reconfiguration mechanism for a robot to cross obstacles. The walking mechanism comprises a plurality of pairs of vertical supports, rollers are arranged at the lower ends of the vertical supports, walking rotating motors for driving the rollers are arranged at the bottoms of two pairs of vertical supports at both ends of the walking mechanism, and the vertical supports on the same side are sequentially connected and fixed by transverse connecting rods. The reconfiguration mechanism is arranged between each pair of vertical supports, and the reconfiguration mechanism comprises two reconfiguration arms.

### CROSS-REFERENCE TO RELATED APPLICATION

This patent application claims the benefit and priority of Chinese Patent Application No. 202210425700.X, filed with the China National Intellectual Property Administration on Apr. 22, 2022, the disclosure of which is incorporated by reference herein in its entirety as part of the present application.

### TECHNICAL HELD

The present disclosure relates to the technical field of agricultural automation equipment, in particular to a mulch film laying robot and a mulch film laying method.

### BACKGROUND

In the prior art, mulching film refers to a measure of covering the ground with agricultural plastic films. It can effectively reduce the evaporation of soil moisture, and has the functions of preserving soil moisture in drought and raising soil moisture after rain. However, the existing mulching device is only suitable for the environment without obstacles on the ground, and the mulch film laying operation for other cash crops, such as fruit trees, green trees, grape trellis or rhizomes which may block off the mulch film laying mechanism, cannot be carried out, and manual laying consumes a lot of manpower, material resources and time. Meanwhile, the existing mulching device has no function of flattening the film, and is poor in laying effect. Therefore, there is an urgent need of a reconfigurable mulch film laying robot.

### SUMMARY

For the problems above, the present disclosure provides a mulch film laying robot and a mulch film laying method.

The present disclosure provides the following technical solutions: a mulch film laying robot includes a walking mechanism for walking, a mulch film laying mechanism for mulch film laying, a mulch film compaction mechanism for compacting a laid mulch film, and a reconfiguration mechanism for a robot to cross an obstacle.

The walking mechanism includes a plurality of pairs of vertical supports, rollers are arranged at the lower ends of the vertical supports, and the bottoms of two pairs of vertical supports at the two ends of the walking mechanism are provided with walking rotating motors for driving the rollers. The vertical supports on the same side are connected and fixed by transverse connecting rods in sequence. The vertical supports on the same side may achieve synchronous action through the connection of the transverse connecting rods, and the stability of the walking mechanism is also guaranteed at the same time.

A reconfiguration mechanism is arranged between each pair of vertical supports. The reconfiguration mechanism includes two reconfiguration arms, and the two reconstruction arms are movably connected to two vertical supports, respectively. A reconfiguration rotating motor for driving the reconfiguration arm to rotate is arranged on the vertical support, and the two reconfiguration arms are connected by an electromagnet. The adoption of the electromagnet is conducive to the opening and closing of the reconfiguration arms, and the reconfiguration arms may be opened and closed according to actual production demands.

The mulch film laying mechanism includes a mulch film roller shaft for laying a mulch film, and a mulch film roller shaft rotating motor for driving the mulch film roller shaft to rotate is arranged on the vertical support. The mulch film roller shaft is driven to rotate by the mulch film roller shaft rotating motor for mulch film laying.

The mulch film compaction mechanism includes a compaction roller shaft, and the compaction roller shaft is connected to the reconfiguration arm by the vertical connecting rod. The mulch film compaction mechanism is arranged on the inner side of the vertical support behind the vertical support corresponding to the mulch film laying mechanism.

The walking mechanism includes three pairs of vertical supports, two pairs of transverse connecting rods and six pairs of rollers. Each pair of two vertical supports are arranged in parallel, the planes where each pair of vertical supports are located are parallel to each other, and three pairs of vertical supports are uniformly arranged front and back. The three vertical supports on each side are fixedly connected by an upper transverse connecting rod and a lower transverse connecting rod. The bottom ends of the pair of vertical supports at the head each are provided with a pair of head wheels, the bottom ends of the pair of vertical supports in the middle each are provided with a pair of middle wheels, and the bottom ends of the pair of vertical supports at the tail each are provided with a pair of tail wheels. The head wheels and the tail wheels each are provided with the walking rotating motor for driving the wheels to rotate.

A total of three pairs of reconfiguration mechanisms are provided. Each pair of reconfiguration mechanisms includes a pair of rotating motors, a pair of telescopic reconfiguration arms, and an electromagnet-iron block combination. The reconfiguration mechanisms are horizontally installed at the top ends of the vertical supports, respectively, and the two reconfiguration arms of each pair of reconfiguration mechanisms are arranged collinearly. The straight line where the reconfiguration arm is located is perpendicular to an advancing direction of the robot, the starting end of the reconfiguration arm is connected to the vertical support by the reconfiguration rotating motor, and the reconfiguration rotating motor is configured to drive the reconfiguration arm to lift upwards; and the tail ends of two reconfiguration arms are connected through the adsorption of the electromagnet and the iron block.

The mulch film laying mechanism includes two mulch film roller shafts, the mulch film laying mechanism is installed at the bottom ends of the pair of vertical supports in the middle, and the two mulch film roller shafts are alternately arranged front and back. The axis of each mulch film roller shaft is perpendicular to the advancing direction of the robot; the vertical support is connected to the mulch film roller shaft rotating motor by a universal joint coupling, and the mulch film roller shaft rotating motor is connected to the mulch film roller shaft and are configured to drive the mulch film roller shaft to rotate.

Two reconfiguration arms of the reconfiguration mechanism in the middle part are connected to the mulch film roller shafts by two vertical connecting rods, respectively. Each reconfiguration arm is connected to the mulch film roller shaft fixed to the same vertical connecting rod, and the vertical connecting rod and the mulch film roller shaft rotating motor are respectively connected to the two ends of the mulch film roller shaft. The reconfiguration arm is provided with the transverse connecting rod, and the transverse connecting rod is connected to the vertical connecting rod by a universal joint coupling. A laying connecting rod spring is arranged between the universal joint coupling and the vertical connecting rod, and a thin film pressure sensor is arranged at the joint of the lay connecting rod spring and the vertical connecting rod.

The mulch film compaction mechanism includes a pair of compaction roller shafts, the two compaction roller shafts are arranged collinearly, and an axis direction of each compaction roller shaft is perpendicular to the advancing direction of the robot. The mulch film compaction mechanism is installed on the reconfiguration mechanism at the tail, vertical connecting rods are respectively installed on two reconfiguration arms of the tail reconfiguration mechanism, and the vertical connecting rods are in one-to-one correspondence with the compaction roller shafts. The upper part of the vertical connecting rod is connected to a universal joint coupling by a compaction ejector spring, and a thin film pressure sensor is arranged between the compaction ejector spring and the vertical connecting rod. The universal joint coupling is fixedly connected to the reconfiguration arm, and the lower part of the vertical connecting rod is connected to the compaction roller shaft.

The walking mechanism is provided with a plurality of laser sensors for sensing obstacles. The laser sensors are connected to a controller, and the controller is respectively connected to the walking rotating motor, the reconfiguration rotating motor, the electromagnet, the mulch film rolling rotating motor and the thin film pressure sensor. The reconfiguration arm is a telescopic reconfiguration arm driven to extend and retract by a linear motor, the linear motor is connected to the controller; and the ends, close to each other, of the two reconfiguration arms in each reconfiguration mechanism are respectively provided with an electromagnet and an iron block.

The laser sensors each are a lidar sensor. The lidar sensors are arranged on the vertical support below the reconfiguration rotating motor, and the lidar sensors are arranged on the vertical supports on the same side.

The laser sensors each are a laser ranging sensor. Three groups of laser ranging sensors are provided, and each group of laser ranging sensors includes two laser ranging sensors. The laser ranging sensors are arranged on the transverse connecting rod on the same side, and each group of laser ranging sensors corresponds to one vertical support. The two laser ranging sensors in each group are respectively arranged on the transverse connecting rod on both sides of the vertical support.

A mulch film laying method based on the robot above includes the following steps: during a mulch film laying operation, the head wheels and the tail wheels are respectively driven to rotate by the walking rotating motors in the middle of the rollers during the advancement of the robot, thus achieving the overall movement of the robot. During the movement of the robot, the mulch film roller shafts are driven to rotate by the mulch film roller shaft rotating motors for mulch film laying. The mulch film roller shafts on the left and right sides are installed front and back in a staggered manner, so the mulching mode is to alternately stagger and overlap the mulch films front and back. In order to attach the mulch film tightly to the ground, the thin film pressure sensors are configured to sense the pressure in time. When the pressure exceeds or is lower than a set threshold, the reconfiguration rotating motors rotate to reduce or increase the pressure of the mulch film roller shafts, thus ensuring that the pressure of the mulch film laying mechanism is within the set range for mulch film laying. The mulch film laying mechanism is designed below the tail reconfiguration mechanism, and pressure values of the compaction roller shafts are obtained through the thin film pressure sensors. In a case that the pressure of the compaction roller shafts exceeds or is less than a set threshold, the reconfiguration rotating motors 431 and 432 of the tail reconfiguration mechanism rotate to reduce or increase the pressure of the compaction roller shafts, thus ensuring that the pressure of the mulch film compaction mechanism is within the set range to compact the previously laid mulch film.

In the process that the robot advances as a whole, when the lidar sensor at the side face of the first pair of reconfiguration arms detects an obstacle in front, the electromagnet of the first pair of reconfiguration arms is powered off and demagnetized to be disconnected from the iron block. The rotating motors at the two ends of the reconfiguration arms drive the reconfiguration arms to lift upwards to the vertical position, then the robot is able to move forwards across the obstacle. In a case that the lidar sensor detects that the obstacle is close to the lidar sensor, i.e., the width of the obstacle is able to be greater than that of the robot, all three pairs of reconfiguration arms can extend at equal distances to ensure that the robot can pass through the obstacle. When the lidar sensor detects that the obstacle disappears within the detection range, the two reconfiguration arms corresponding to the lidar sensor first fall back to the initial positions, and the electromagnet at the joint is electrified to generate magnetism so as to be connected to the iron block by attraction. Even before the reconfiguration arms fall back to be connected, other two pairs of reconfiguration mechanisms are still kept at a connection state, and thus the robot is still a stable whole. When the robot moves forwards, the mulch film laying mechanism performs the mulch film laying operation, and the mulch film compaction mechanism performs the mulch film compacting operation.

When the lidar sensor on the side face of the second pair of reconfiguration mechanisms detects an obstacle in front, the same operation as the front reconfiguration arms is conducted. In the process of lifting the reconfiguration arms, the mulch film roller shafts of the mulch film laying mechanism are also lifted through the driving of the universal joint couplings and the vertical connecting rods, and the joints between the mulch film roller shafts and the vertical supports located in the middle are also provided with universal joint couplings, thus the reconfiguration arms and the roller shafts can be lifted up or fall back simultaneously. When the lidar sensor does not detect an obstacle, the same operation as the front reconfiguration arms is conducted.

When the lidar sensor on the side face of the third pair of reconfiguration mechanisms detects an obstacle in front, the same operation as the front reconfiguration arms is conducted. In the process of lifting the reconfiguration arms, the mulch film compaction roller shafts of the mulch film compaction mechanism are also lifted through the driving of the universal joint couplings and the vertical connecting rods. As the compaction roller shafts are only connected to the vertical connecting rods rather than other universal joint couplings, the reconfiguration arms and the roller shafts can be lifted up or fall back simultaneously. When the lidar sensor does not detect the obstacle, the same operation as the front reconfiguration arms is conducted. After the three pairs of reconfiguration mechanisms all pass through the obstacle, the extended reconfiguration arms are able to retract to the initial positions.

When the lidar sensors are replaced with the laser ranging sensors, whether the obstacle is in front of the reconfiguration arms or not is detected by the front laser ranging sensor of a pair of laser ranging sensors corresponding to the reconfiguration arm, and whether the obstacle behind disappears is detected by the rear laser ranging sensor of the pair of laser ranging sensors. The rest reconfiguration mechanisms are the same, and the rest of operations remain unchanged.

In accordance with the present disclosure, the iron blocks may be arranged on the reconfiguration arms on the same side, the laser sensors may be arranged on the walking mechanism on the side where the iron blocks are arranged, and there may be two controllers, all of which are well-known single-chip controllers. The two single-chip controllers are in communication with each other, one of the single-chip controllers and four motor drivers are installed outside the bottom ends of a pair of vertical supports located in the middle, and the other of the single-chip controllers and the other four motor drives are installed on the other side. The electromagnets on the electromagnet side are connected to the single-chip controller on this side. Two thin film pressure sensors on this side (the thin film pressure sensor corresponding to one mulch film roller shaft and the thin film pressure sensor corresponding to one compaction roller shaft) are connected to the single-chip controller on this side. The head wheel and the tail wheel on this side and the motor of the mulch film roller shaft of the mulch film laying mechanism are connected to the same motor driver, the three reconfiguration rotating motors for controlling the reconfiguration arms on this side are respectively connected to three motor drivers, and the four motor drivers are then connected to the single-chip controller on this side. The laser radars on the iron block side are connected to the single-chip controller. Two thin film pressure sensors on this side (the thin film pressure sensor corresponding to one mulch film roller shaft and the thin film pressure sensor corresponding to one compaction roller shaft) are connected to the single-chip controller on this side. The head wheel and the tail wheel on this side and the mulch film roller shaft rotating motor of the mulch film roller shaft of the mulch film laying mechanism are connected to the same motor driver, the three motors for controlling the reconfiguration arms on this side are respectively connected to three motor drivers, and the four motor drivers are then connected to the single-chip controller.

During the installation of the mulch film roller shaft, a round hole is formed in the bottom end of the vertical support in the middle, and a polished shaft is inserted into the round hole. A stopper is installed at the tail end of the polished shaft in the vertical support to prevent the polished shaft from falling off. A bearing is installed at the position of the round hole, the vertical support is connected to the universal joint coupling through the polished shaft, the universal joint coupling is fixedly connected to the mulch film roller shaft rotating motor through the polished shaft, and the mulch film roller shaft rotating motor is connected to the mulch film roller shaft and drives the roller shaft to rotate. The other end, with respect to the mulch film roller shaft rotating motor, of the mulch film roller shaft of the mulch film laying mechanism is inserted into the polished shaft, a stopper is installed at the tail end of the polished shaft in the mulch film roller shaft, a bearing is installed at the position where the polished shaft is inserted into the roller shaft, and the lower part of the vertical connecting rod is connected to the polished shaft by the universal joint coupling. A bearing is installed at the position at which the outer side of the compaction roller shaft of the mulch film compaction mechanism is inserted into the vertical connecting rod, and the compaction roller shaft is connected to the third pair of reconfiguration arms through the vertical connecting rod. The reconfiguration arms of the reconfiguration mechanism may all be extended within a certain range, and thus the whole robot is widened to pass through some complicated obstacles. The mulch film roller shaft of the mulch film laying mechanism can also be extended within a certain range to ensure that the front mulch film roller shaft and the rear mulch film roller shaft have overlapping parts.

It can be obtained from the above description that, during the advancement of the robot, the head wheels and the tail wheels are respectively driven to rotate by the walking rotating motors, thus achieving the whole movement of the robot. During movement, the mulch film roller shafts of the mulch film laying mechanism are driven to rotate by the mulch film roller shaft rotating motors, i.e., the mulch film laying mechanism simultaneously lays the mulch film. The mulch film roller shafts on the left and right sides are installed front and back in a staggered manner, so the mulching mode is to alternately stagger and overlap the mulch films front and back. In order to attach the mulch film tightly to the ground, through the closed-loop control of the thin film pressure sensors and the motors, the pressure of the mulch film laying mechanism is ensured to be in the most suitable range for mulch film laying. Meanwhile, the mulch film compaction mechanism is designed below the third pair of reconfiguration mechanisms, and through the closed-loop control of the thin film pressure sensors and the motors, the pressure of the mulch film compaction mechanism is ensured to be in the most suitable range for compacting the previously covered mulch film. In accordance with the solution, when encountering an obstacle, the robot is subjected to deconstruction to pass through the obstacle from both sides for continuous mulch film laying, and the problems of time and energy waste and difficult laying when the mulch film is laid in an environment with the obstacle in the middle are solved.

### BRIEF DESCRIPTION OF THE DRAWINGS

FIG. 1 is a structure diagram in accordance with the present disclosure.

FIG. 2 is a structure diagram of a first pair of reconfiguration mechanisms in accordance with the present disclosure.

FIG. 3 is a structure diagram of a second pair of reconfiguration mechanisms in accordance with the present disclosure.

FIG. 4 is a structure diagram of a third pair of reconfiguration mechanisms in accordance with the present disclosure.

FIG. 5 is a schematic diagram of an installation position of a lidar sensor in accordance with the present disclosure.

FIG. 6 is a schematic diagram of an installation position of a laser ranging sensor in accordance with the present disclosure.

FIG. 7 is a schematic diagram of the coverage area of a laser radar in accordance with the present disclosure.

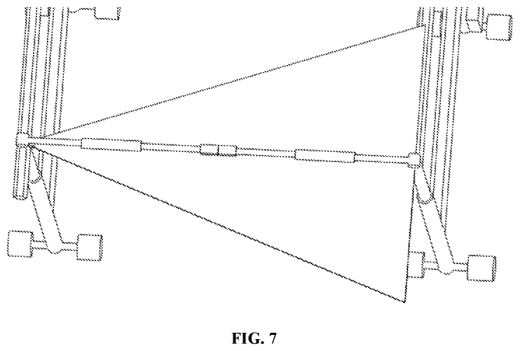

FIG. 8 is a structure diagram of the lifting of a third pair of reconfiguration mechanisms in accordance with the present disclosure.

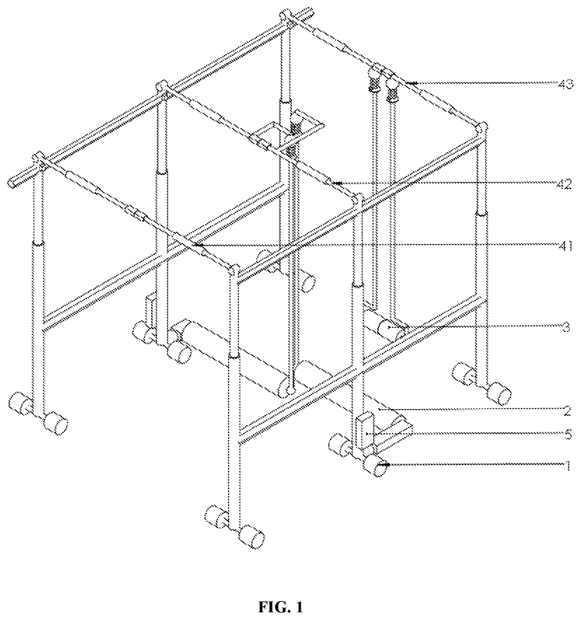

In the FIG. 1: 1—walking mechanism; 2—mulch film laying mechanism; 3—mulch film compaction mechanism; 41—first pair of reconfiguration mechanisms; 42—second pair of reconfiguration mechanisms; 43—third pair of reconfiguration mechanisms; 5—control system.

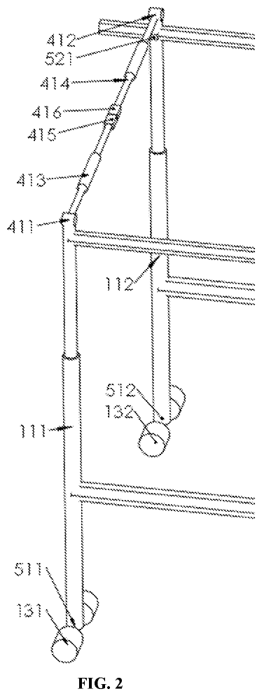

In the FIG. 2: 131, 132—head wheel, 511, 512—walking rotating motor; 111, 112—first pair of vertical supports; 411, 412—reconfiguration rotating motor; 413, 414—reconfiguration arm; 415—electromagnet; 416—iron block; 521—lidar sensor;

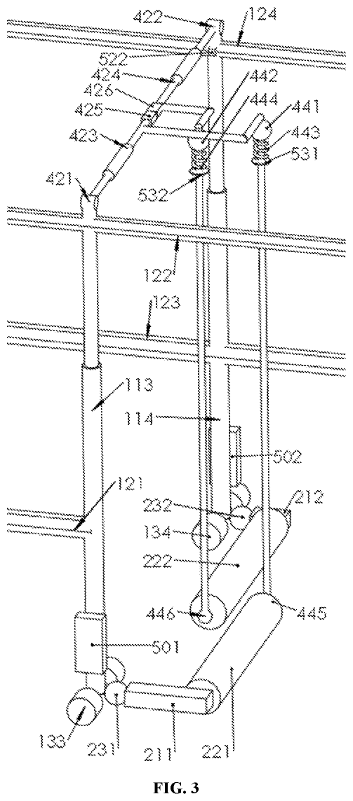

In the FIG. 3: 501, 502—single—chip controller and motor driver; 133, 134—middle wheel; 211, 212—mulch film roller shaft rotating motor; 221, 222—mulch film roller shaft; 231, 232—first pair of universal joint couplings; 113, 114—second pairs of vertical supports; 121 to 124—transverse connecting rod; 421, 422—reconfiguration rotating motor; 423, 424—reconfiguration arm; 425—electromagnet; 426—iron block; 522—lidar sensor; 441, 442—universal joint coupling; 443, 444—laying connecting rod spring, 445, 446—second pair of universal joint coupling; 531, 532—first group of thin film pressure sensors.

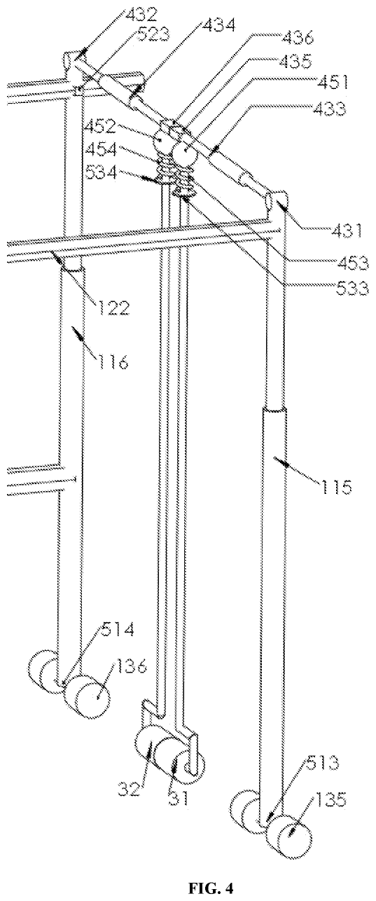

In the FIG. 4: 135, 136—tail wheel, 513, 514—walking rotating motor; 31, 32—compaction roller shaft, 115, 116—third pair of vertical supports; 431, 432—reconfiguration rotating motor; 433, 434—reconfiguration arm; 435—electromagnet; 436—iron block; 523—lidar sensor; 451, 452—universal joint coupling; 453, 454—compaction ejector spring; 533, 534—second group of thin film pressure sensors.

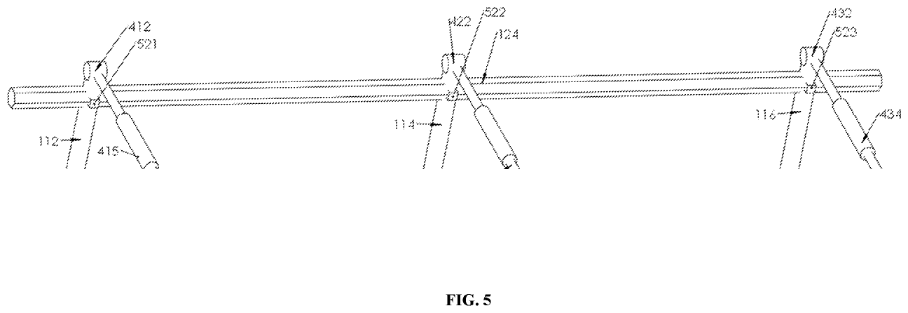

In the FIGS. 5: 521 to 523—lidar sensor.

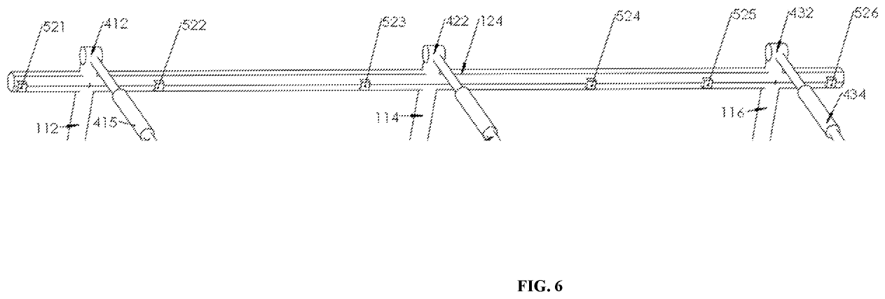

In the FIGS. 6: 521 to 526—laser ranging sensor.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

It can be seen from the drawings that a reconfigurable mulch film laying robot provided by the present disclosure includes a walking mechanism 1, a mulch film laying mechanism 2, a mulch film compaction mechanism 3, a reconfiguration mechanism, and a control system 5. The walking mechanism 1 includes three pairs of vertical supports 111-116, two pairs of transverse connecting rods 121-124, and six pairs of rollers 131-136. Each pair of two vertical supports are arranged in parallel, three pairs of vertical supports are uniformly spaced at a certain distance from each other. Three vertical supports on each side are fixedly connected by an upper transverse connecting rod and a lower transverse connecting rod. The bottom ends of the pair of vertical supports 111 and 112 at the head part each are provided with a pair of head wheels 131 and 132, the bottom ends of the pair of vertical supports 113 and 114 in the middle each are provided with two pairs of middle wheels 133 and 134, and the pair of vertical supports 115 and 116 located at the tail part each are provided with two pairs of tail wheels 135 and 136.

The mulch film laying mechanism 2 includes a pair of mulch film roller shaft rotating motors 211 and 212 and a pair of mulch film roller shafts 221 and 222. The mulch film laying mechanism is installed at the bottom ends of the pair of vertical supports 113 and 114 in the middle, the two mulch film roller shafts 221 and 222 are arranged front and back in a staggered manner, and an installation direction of the mulch film roller shaft is perpendicular to an advancing direction. The vertical supports 113 and 114 are connected to mulch film roller shaft rotating motors 211 and 212 by universal joint couplings 231 and 232, respectively. The mulch film roller shaft rotating motor 211 is connected to the mulch film roller shaft 221, the mulch film roller shaft rotating motor 212 is connected to the mulch film roller shaft 222, and the mulch film roller shaft rotating motor drives the mulch film roller shaft to rotate.

The mulch film compaction mechanism 3 includes a pair of compaction roller shafts 31 and 32. The mulch film compaction mechanism is installed at the bottom ends of the pair of vertical supports 115 and 116 at the tail part, the two compaction roller shafts 31 and 32 are arranged collinearly, and an installation direction of the compaction roller shaft is perpendicular to the advancing direction of the robot.

A total of three pairs of reconfiguration mechanisms 4 are provided. Each pair of reconfiguration mechanisms comprise a pair of rotating motors, a pair of telescopic reconfiguration arms, and an electromagnet-iron block combination. The reconfiguration mechanisms are horizontally installed at the top ends of the vertical supports 111 to 116, respectively, and the two reconfiguration arms of each pair of reconfiguration mechanisms are arranged collinearly. The straight line where the reconfiguration arm is located is perpendicular to the advancing direction of the robot. The starting end of the reconfiguration arm is connected to the vertical support by the reconfiguration rotating motor, and the reconfiguration rotating motor is configured to drive the reconfiguration arm to lift upwards; and the tail ends of two reconfiguration arms are connected through the adsorption of the electromagnet and the iron block.

The second pair of reconfiguration mechanisms 42 (the reconfiguration mechanisms at the middle part) are connected to the mulch film laying mechanism 2 below by vertical connecting rods. The vertical connecting rods are located at the tail ends of the reconfiguration arms, the upper parts of the vertical connecting rods are fixedly connected to the reconfiguration arms through universal joint couplings 441 and 442 and laying connecting springs 443 and 444, and the lower parts of the vertical connecting rods are respectively connected to the mulch film roller shafts 221 and 222 by the second pairs of universal joint couplings 445 and 446. A first group of thin film pressure sensors 531 and 532 are arranged between the laying connecting rod springs 443 and 444 and the vertical connecting rods.

The third pair of reconfiguration mechanisms 43 are connected to the mulch film compaction mechanism 3 below through the third pairs of vertical connecting rods 115 and 116. The vertical connecting rods are located at the tail ends of the reconfiguration arms, the upper parts of the vertical connecting rods are fixedly connected to the reconfiguration arms through universal joint couplings 451 and 452 and compaction ejector springs 453 and 454, and the lower parts of the vertical connecting rods are respectively connected to the compaction roller shafts 31 and 32. A second group of thin film pressure sensors 533 and 534 are arranged between the compaction ejector springs 453 and 454 and the vertical connecting rods.

The control system 5 includes a pair of single-chip controllers, four pairs of motor drivers, six pairs of rotating motors, three pairs of electromagnets and iron blocks, three lidar sensors or six laser ranging sensors, as well as two pairs of thin film pressure sensors. The lidar sensor employs an Livox Mid-100 lidar sensor, the laser ranging sensor employs a GY-53 laser ranging sensor, the thin film pressure sensor employs a DF9-40 thin film pressure, and the motor driver employs an electric driver commonly used in the field.

One single-chip controller and four motor drivers 501 are installed outside the bottom end of the vertical support 113, the other single-chip controller and the other four motor drivers 502 are installed outside the bottom end of the vertical support 114. Two walking rotating motors 511 and 512 are respectively installed at the middle parts of two rollers of the head wheels 131 and 132, and two walking rotating motors 513 and 514 are respectively installed at the middle parts of two rollers of the tail wheels 135 and 136. Two mulch film roller shaft rotating motors 211 and 212 are respectively installed on both sides of the mulch film roller shafts 221 and 222 of the mulch film laying mechanism. Two reconfiguration rotating motors 411 and 412 are respectively installed at the starting ends of the reconfiguration arms 413 and 414. Two reconfiguration rotating motors 421 and 422 are respectively installed at the starting ends of the reconfiguration arms 423 and 424. The two reconfiguration rotating motors 431 and 432 are respectively installed at the starting ends of the reconfiguration arms 433 and 434. The electromagnet 415 and the iron block 416 are respectively installed at the tail ends of the reconfiguration arms 413 and 414; the electromagnet 425 and the iron block 426 are respectively installed at the tail ends of the reconfiguration arms 423 and 424; and the electromagnet 435 and the iron block 436 are respectively installed at the tail ends of the reconfiguration arms 433 and 434. The three electromagnets are located on the same side, and the three iron blocks are located on the other side. The three lidar sensors 521 to 523 are respectively installed on the inner side of the upper transverse connecting rod 124 on the iron block side, the front and rear positions thereof coincide with three pairs of vertical supports, respectively, and the installation directions are horizontally inward.

The lidar sensors may be replaced with the laser ranging sensors 521 to 526. When using the laser ranging sensors, six laser ranging sensors are required. The six laser ranging sensors are installed on the inner side of the upper transverse connecting rod 124 on the iron block side, and the front and rear positions of each pair are respectively on the front and rear sides of each vertical support, and the installation direction is horizontally inward.

The electromagnets on the electromagnet side are connected to the single-chip controller. The two thin film pressure sensors on this side (the thin film pressure sensor of one mulch film laying mechanism and the thin film pressure sensor of one mulch film compaction mechanism) are connected to the single-chip controller on this side. The head wheel and the tail wheel on this side and the motor of the roller shaft of the mulch film laying mechanism are connected to the same motor driver, the three motors for controlling the reconfiguration arms on this side are respectively connected to three motor drivers, and the four motor drivers are then connected to the single-chip controller.

The laser radars on the iron block side are connected to the single-chip controller. The two thin film pressure sensors on this side (the thin film pressure sensor of one mulch film laying mechanism and the thin film pressure sensor of one mulch film compaction mechanism) are connected to the single-chip controller on this side. The head wheel and the tail wheel on this side and the motor of the roller shaft of the mulch film laying mechanism are connected to the same motor driver, the three motors for controlling the reconfiguration arms on this side are respectively connected to three motor drivers, and the four motor drivers are then connected to the single-chip controller.

During operation, during the advancement of the robot, the head wheels 131 and 132 and the tail wheels 135 and 136 are respectively driven to rotate by the rotating motors at the middle part of the rollers, thus achieving the whole movement of the robot. During movement, the rotating motors 211 and 212 drive the roller shafts 221 and 222 of the mulch film laying mechanism to rotate, i.e., the mulch film laying mechanism lays the mulch film at the same time. The roller shafts on the left and right sides are installed front and back in a staggered manner, so the mulching mode is to alternately stagger and overlap mulch films front and back. In order to attach the mulch film tightly to the ground, through the closed-loop control of the thin film pressure sensors 531 to 532 and the rotating motors 421 and 422, the pressure of the mulch film laying mechanism is ensured to be in the most suitable range for mulch film laying. Meanwhile, the mulch film compaction mechanism is designed below the third pair of reconfiguration mechanisms, and through the closed-loop control of the thin film pressure sensors 533 to 534 and the rotating motors 431 and 432, the pressure of the mulch film compaction mechanism is ensured to be in the most suitable pressure for compacting the previously covered mulch film.

As shown in FIG. 2, during the advancement of the whole robot, when the lidar sensor 521 on the side face of the first pair of reconfiguration mechanisms 41 detects an obstacle in front, the single-chip controller 502 on the iron block side may perform communication with the single-chip controller 501 on the electromagnet side for information transmission. Under the control of the single-chip controller 501 on the electromagnet side, the electromagnet 415 may be powered off and demagnetized, i.e., the electromagnet 415 is disconnected from the iron block 416. Afterwards, the rotating motors 411 and 412 at the two ends of the reconfiguration arms are controlled to driven the reconfiguration arms 413 and 414 to lift upwards to the vertical position, and the whole robot moves forwards. In a case that the laser radar detects that the obstacle is particularly close to the laser radar, i.e., the width of the obstacle may be greater than that of the robot, the three pairs of reconfiguration arms can extend at equal distances to ensure that the robot can pass through the obstacle. When the lidar sensor 521 detects that the obstacle disappears within the detection range, the reconfiguration arms 413 and 414 fall back to the initial positions, and then the electromagnet 415 at the joint is electrified to generate magnetism so as to be connected to the iron block 416. Even before the reconfiguration arms fall back to be connected, other two pairs of reconfiguration mechanisms are still kept at a connection state, and thus the robot is still a stable whole. While moving forward, the mulch film laying mechanism 2 performs mulch film laying operation, and the mulch film compaction mechanism 3 performs mulch film compacting operation.

As shown in FIG. 3, when the lidar sensor 522 on the side face of the second pair of reconfiguration mechanisms 42 detects an obstacle in front, the same operation as the front reconfiguration arms is conducted. In the process of lifting the reconfiguration arms, the mulch film roller shafts 221 and 222 of the mulch film laying mechanism are also lifted through the driving of the universal joint couplings 441 and 442 and the vertical connecting rods 2, and the joints between the mulch film roller shafts and the vertical supports 113 and 114 located in the middle are also provided with the universal joint couplings 231 and 232, thus the reconfiguration arms and the mulch film roller shafts can be lifted up and fall back simultaneously. When the lidar sensor 522 does not detect an obstacle, the same operation as the front reconfiguration arms can be conducted.

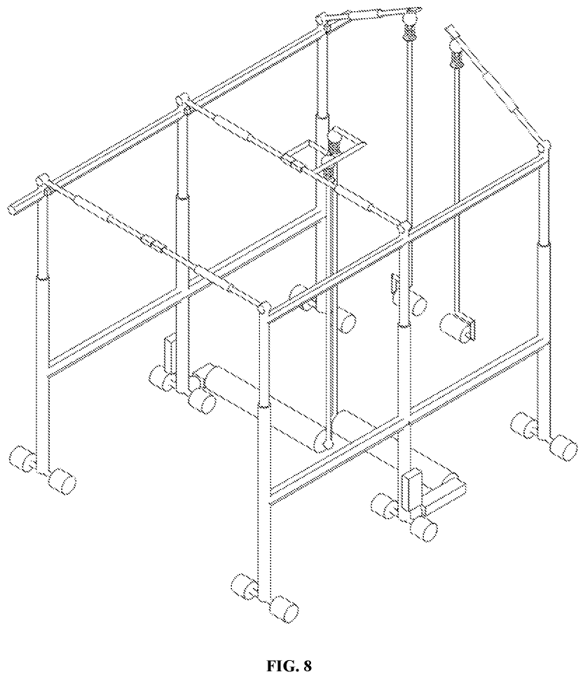

As shown in FIG. 4 and FIG. 8, when the lidar sensor 523 on the side face of the third pair of reconfiguration mechanisms 43 detects an obstacle in front, the same operation as the front reconfiguration arms is conducted. In the process of lifting the reconfiguration arms, the mulch film compaction roller shafts 31 and 32 of the mulch film compaction mechanism are also lifted through the driving of the universal joint couplings 451 and 452 and the vertical connecting rods. As the compaction roller shafts are only connected to the vertical connecting rods rather than other universal joint couplings, the reconfiguration arms and the roller shafts are able to be lifted up or fall back simultaneously. When the lidar sensor 523 does not detect an obstacle, the same operation as the front reconfiguration arms is conducted. After the three pairs of reconfiguration mechanisms all pass through the obstacle, the extended reconfiguration arms can retract to the initial positions.

As shown in FIG. 6, when the lidar sensors are replaced with the laser ranging sensors, each pair of reconfiguration mechanisms corresponds to two laser ranging sensors, one of the ranging sensors is arranged in front of the reconfiguration mechanism, and the other of the ranging sensors is arranged behind the reconfiguration mechanism. Moreover, the rear laser ranging sensor 524 corresponding to the second pair of reconfiguration mechanisms is arranged behind the vertical plane where the mulch film roller shaft is located. Whether there is an obstacle in front of the reconfiguration mechanism 41 is detected by the laser ranging sensor 521, and whether the obstacle behind disappears is detected by the laser ranging sensor 522. The other reconstruction mechanisms are the same, and the rest of the operations remain unchanged.

While the specific embodiments of the present disclosure have been shown and described, it may be understood by those skilled in the art that many changes, modifications, substitutions and variations can be made to these specific embodiments without departing from the principle and spirit of the present disclosure, and the scope of the present disclosure is defined by the appended claims and their equivalents.

1. A mulch film laying robot, comprising a walking mechanism for walking, a mulch film laying mechanism for mulch film laying, a mulch film compaction mechanism for compacting a laid mulch film, and a reconfiguration mechanism for a robot to cross an obstacle;
the walking mechanism comprises a plurality of pairs of vertical supports, rollers are arranged at the lower ends of the vertical supports, walking rotating motors for driving the rollers are arranged at the bottoms of two pairs of vertical supports at both ends of the walking mechanism, and the vertical supports on the same side are sequentially connected and fixed by transverse connecting rods;
a reconfiguration mechanism is arranged between each pair of vertical supports, and the reconfiguration mechanism comprises two reconfiguration arms; the two reconstruction arms are movably connected to two vertical supports, respectively; a reconfiguration rotating motor for driving the reconfiguration arm to rotate is arranged on the vertical support, and the two reconfiguration arms are connected by an electromagnet;
the mulch film laying mechanism comprises a mulch film roller shaft for laying a mulch film, and a mulch film roller shaft rotating motor for driving the mulch film roller shaft to rotate is arranged on the vertical support;
the mulch film compaction mechanism comprises a compaction roller shaft, the compaction roller shaft is connected to the reconfiguration arm by a vertical connecting rod, and the mulch film compaction mechanism is arranged on the inner side of the vertical support behind the vertical support corresponding to the mulch film laying mechanism.

2. The mulch film laying robot according to claim 1, wherein
the walking mechanism comprises three pairs of vertical supports, two pairs of transverse connecting rods and six pairs of rollers; each pair of two vertical supports are arranged in parallel, the planes where each pair of vertical supports are located are parallel to each other, and three pairs of vertical supports are uniformly arranged front and back; the three vertical supports on each side are fixedly connected by an upper transverse connecting rod and a lower transverse connecting rod; the bottom ends of the pair of vertical supports at the head each are provided with a pair of head wheels, the bottom ends of the pair of vertical supports in the middle each are provided with a pair of middle wheels, and the bottom ends of the pair of vertical supports at the tail each are provided with a pair of tail wheels; and the head wheels and the tail wheels each are provided with the walking rotating motor for driving the wheels to rotate.

3. The mulch film laying robot according to claim 1, wherein
a total of three pairs of reconfiguration mechanisms are provided, each pair of reconfiguration mechanisms comprises a pair of rotating motors, a pair of telescopic reconfiguration arms, and an electromagnet-iron block combination; the reconfiguration mechanisms are horizontally installed at the top ends of the vertical supports, respectively, and the two reconfiguration arms of each pair of reconfiguration mechanisms are arranged collinearly; the straight line where the reconfiguration arm is located is perpendicular to an advancing direction of the robot, the starting end of the reconfiguration arm is connected to the vertical support by the reconfiguration rotating motor, and the reconfiguration rotating motor is configured to drive the reconfiguration arm to lift upwards; and the tail ends of two reconfiguration arms are connected through the adsorption of the electromagnet and the iron block.

4. The mulch film laying robot according to claim 3, wherein
the mulch film laying mechanism comprises two mulch film roller shafts, the mulch film laying mechanism is installed at the bottom ends of the pair of vertical supports in the middle, and the two mulch film roller shafts are alternately arranged front and back; the axis of each mulch film roller shaft is perpendicular to the advancing direction of the robot; the vertical support is connected to the mulch film roller shaft rotating motor by a universal joint coupling, and the mulch film roller shaft rotating motor is connected to the mulch film roller shaft and are configured to drive the mulch film roller shaft to rotate.

5. The mulch film laying robot according to claim 4, wherein
two reconfiguration arms of the reconfiguration mechanism in the middle part are connected to the mulch film roller shafts by two vertical connecting rods, respectively; each reconfiguration arm is connected to the mulch film roller shaft fixed to the same vertical connecting rod, and the vertical connecting rod and the mulch film roller shaft rotating motor are respectively connected to the two ends of the mulch film roller shaft; the reconfiguration arm is provided with the transverse connecting rod, and the transverse connecting rod is connected to the vertical connecting rod by a universal joint coupling; and a laying connecting rod spring is arranged between the universal joint coupling and the vertical connecting rod, and a thin film pressure sensor is arranged at the joint of the lay connecting rod spring and the vertical connecting rod.

6. The mulch film laying robot according to claim 5, wherein
the mulch film compaction mechanism comprises a pair of compaction roller shafts, the two compaction roller shafts are arranged collinearly, an axis direction of each compaction roller shaft is perpendicular to the advancing direction of the robot; the mulch film compaction mechanism is installed on the reconfiguration mechanism at the tail, vertical connecting rods are respectively installed on two reconfiguration arms of the tail reconfiguration mechanism, and the vertical connecting rods are in one-to-one correspondence with the compaction roller shafts; the upper part of the vertical connecting rod is connected to a universal joint coupling by a compaction ejector spring, and a thin film pressure sensor is arranged between the compaction ejector spring and the vertical connecting rod; and the universal joint coupling is fixedly connected to the reconfiguration arm, and the lower part of the vertical connecting rod is connected to the compaction roller shaft.

7. The mulch film laying robot according to claim 6, wherein
the walking mechanism is provided with a plurality of laser sensors for sensing obstacles, the laser sensors are connected to a controller, and the controller is respectively connected to the walking rotating motor, the reconfiguration rotating motor, the electromagnet, the mulch film rolling rotating motor and the thin film pressure sensor; the reconfiguration arm is a telescopic reconfiguration arm driven to extend and retract by a linear motor, the linear motor is connected to the controller; and the ends, close to each other, of the two reconfiguration arms in each reconfiguration mechanism are respectively provided with an electromagnet and an iron block.

8. The mulch film laying robot according to claim 7, wherein
the laser sensors each are a lidar sensor, and the lidar sensors are arranged on the vertical support below the reconfiguration rotating motor; and the lidar sensors are arranged on the vertical supports on the same side.

9. The mulch film laying robot according to claim 7, wherein
the laser sensors each are a laser ranging sensor; three groups of laser ranging sensors are provided, and each group of laser ranging sensors comprises two laser ranging sensors; the laser ranging sensors are arranged on the transverse connecting rod on the same side, and each group of laser ranging sensors corresponds to one vertical support; and the two laser ranging sensors in each group are respectively arranged on the transverse connecting rod on both sides of the vertical support.

10. A mulch film laying method based on the mulch film laying robot according to claim 1, wherein
during a mulch film laying operation, the head wheels 131 and 132 and the tail wheels 135 and 136 are respectively driven to rotate by the walking rotating motors in the middle of the rollers during advancement of the robot, thus achieving the overall movement of the robot; during the movement of the robot, the mulch film roller shafts 221 and 222 are driven to rotate by the mulch film roller shaft rotating motors for mulch film laying; the mulch film roller shafts on the left and right sides are installed front and back in a staggered manner, so the mulching mode is to stagger and overlap the mulch films front and back; in order to attach the mulch film tightly to the ground, the thin film pressure sensors 531 and 532 are configured to sense the pressure in time; when the pressure exceeds or is lower than a set threshold, the reconfiguration rotating motors 421 and 422 rotate to reduce or increase the pressure of the mulch film roller shafts, thus ensuring that the pressure of the mulch film laying mechanism is within the set range for mulch film laying; the mulch film laying mechanism is designed below the tail reconfiguration mechanism, and pressure values of the compaction roller shafts are obtained through the thin film pressure sensors 533 and 534; in a case that the pressure of the compaction roller shafts exceeds or is less than a set threshold, the reconfiguration rotating motors 431 and 432 of the tail reconfiguration mechanism rotate to reduce or increase the pressure of the compaction roller shafts, thus ensuring that the pressure of the mulch film compaction mechanism is within the set range to compact the previously laid mulch film;
in the process that the robot advances as a whole, when the lidar sensor at the side face of the first pair of reconfiguration arms detects an obstacle in front, the electromagnet of the first pair of reconfiguration arms is powered off and demagnetized to be disconnected from the iron block; the rotating motors at the two ends of the reconfiguration arms drive the reconfiguration arms to lift upwards to the vertical position, then the robot is able to move forwards across the obstacle; if the lidar sensor detects that the obstacle is close to the lidar sensor, that is, the width of the obstacle is able to be greater than that of the robot, all three pairs of reconfiguration arms are able to extend at equal distances to ensure that the robot is able to pass through the obstacle; when the lidar sensor detects that the obstacle disappears within the detection range, the two reconfiguration arms corresponding to the lidar sensor first fall back to the initial positions, and the electromagnet at the joint is electrified to generate magnetism so as to be connected to the iron block by attraction; even before the reconfiguration arms fall back to be connected, other two pairs of reconfiguration mechanisms are still kept at a connection state, and thus the robot is still a stable whole; and when the robot moves forwards, the mulch film laying mechanism performs the mulch film laying operation, and the mulch film compaction mechanism performs the mulch film compacting operation;
when the lidar sensor on the side face of the second pair of reconfiguration mechanisms detects an obstacle in front, the same operation as the front reconfiguration arms is conducted; in the process of lifting the reconfiguration arms, the mulch film roller shafts of the mulch film laying mechanism are also lifted through the driving of the universal joint couplings and the vertical connecting rods, and the joints between the mulch film roller shafts and the vertical supports located in the middle are also provided with universal joint couplings, thus the reconfiguration arms and the roller shafts are able to be lifted up or fall back simultaneously; and when the lidar sensor does not detect an obstacle, the same operation as the front reconfiguration arms is conducted;
when the lidar sensor on the side face of the third pair of reconfiguration mechanisms detects an obstacle in front, the same operation as the front reconfiguration arms is conducted; in the process of lifting the reconfiguration arms, the mulch film compaction roller shafts of the mulch film compaction mechanism are also lifted through the driving of the universal joint couplings and the vertical connecting rods, as the compaction roller shafts are only connected to the vertical connecting rods rather than other universal joint couplings, the reconfiguration arms and the roller shafts are able to be lifted up or fall back simultaneously; and when the lidar sensor does not detect the obstacle, the same operation as the front reconfiguration arms is conducted; and after the three pairs of reconfiguration mechanisms all pass through the obstacle, the extended reconfiguration arms are able to retract to the initial positions;
when the lidar sensors are replaced with the laser ranging sensors, whether the obstacle is in front of the reconfiguration arms or not is detected by the front laser ranging sensor of a pair of laser ranging sensors corresponding to the reconfiguration arm, and whether the obstacle behind disappears is detected by the rear laser ranging sensor of the pair of laser ranging sensors; and the rest reconfiguration mechanisms are the same, and the rest of operations remain unchanged.

11. The mulch film laying robot according to claim 2, wherein
a total of three pairs of reconfiguration mechanisms are provided, each pair of reconfiguration mechanisms comprises a pair of rotating motors, a pair of telescopic reconfiguration arms, and an electromagnet-iron block combination; the reconfiguration mechanisms are horizontally installed at the top ends of the vertical supports, respectively, and the two reconfiguration arms of each pair of reconfiguration mechanisms are arranged collinearly; the straight line where the reconfiguration arm is located is perpendicular to an advancing direction of the robot, the starting end of the reconfiguration arm is connected to the vertical support by the reconfiguration rotating motor, and the reconfiguration rotating motor is configured to drive the reconfiguration arm to lift upwards; and the tail ends of two reconfiguration arms are connected through the adsorption of the electromagnet and the iron block.

12. The mulch film laying robot according to claim 11, wherein
the mulch film laying mechanism comprises two mulch film roller shafts, the mulch film laying mechanism is installed at the bottom ends of the pair of vertical supports in the middle, and the two mulch film roller shafts are alternately arranged front and back; the axis of each mulch film roller shaft is perpendicular to the advancing direction of the robot; the vertical support is connected to the mulch film roller shaft rotating motor by a universal joint coupling, and the mulch film roller shaft rotating motor is connected to the mulch film roller shaft and are configured to drive the mulch film roller shaft to rotate.

13. The mulch film laying robot according to claim 12, wherein
two reconfiguration arms of the reconfiguration mechanism in the middle part are connected to the mulch film roller shafts by two vertical connecting rods, respectively; each reconfiguration arm is connected to the mulch film roller shaft fixed to the same vertical connecting rod, and the vertical connecting rod and the mulch film roller shaft rotating motor are respectively connected to the two ends of the mulch film roller shaft; the reconfiguration arm is provided with the transverse connecting rod, and the transverse connecting rod is connected to the vertical connecting rod by a universal joint coupling; and a laying connecting rod spring is arranged between the universal joint coupling and the vertical connecting rod, and a thin film pressure sensor is arranged at the joint of the lay connecting rod spring and the vertical connecting rod.

14. The mulch film laying robot according to claim 13, wherein
the mulch film compaction mechanism comprises a pair of compaction roller shafts, the two compaction roller shafts are arranged collinearly, an axis direction of each compaction roller shaft is perpendicular to the advancing direction of the robot; the mulch film compaction mechanism is installed on the reconfiguration mechanism at the tail, vertical connecting rods are respectively installed on two reconfiguration arms of the tail reconfiguration mechanism, and the vertical connecting rods are in one-to-one correspondence with the compaction roller shafts; the upper part of the vertical connecting rod is connected to a universal joint coupling by a compaction ejector spring, and a thin film pressure sensor is arranged between the compaction ejector spring and the vertical connecting rod; and the universal joint coupling is fixedly connected to the reconfiguration arm, and the lower part of the vertical connecting rod is connected to the compaction roller shaft.

15. The mulch film laying robot according to claim 14, wherein
the walking mechanism is provided with a plurality of laser sensors for sensing obstacles, the laser sensors are connected to a controller, and the controller is respectively connected to the walking rotating motor, the reconfiguration rotating motor, the electromagnet, the mulch film rolling rotating motor and the thin film pressure sensor; the reconfiguration arm is a telescopic reconfiguration arm driven to extend and retract by a linear motor, the linear motor is connected to the controller; and the ends, close to each other, of the two reconfiguration arms in each reconfiguration mechanism are respectively provided with an electromagnet and an iron block.

16. The mulch film laying robot according to claim 15, wherein
the laser sensors each are a lidar sensor, and the lidar sensors are arranged on the vertical support below the reconfiguration rotating motor; and the lidar sensors are arranged on the vertical supports on the same side.

17. The mulch film laying robot according to claim 15, wherein
the laser sensors each are a laser ranging sensor; three groups of laser ranging sensors are provided, and each group of laser ranging sensors comprises two laser ranging sensors; the laser ranging sensors are arranged on the transverse connecting rod on the same side, and each group of laser ranging sensors corresponds to one vertical support; and the two laser ranging sensors in each group are respectively arranged on the transverse connecting rod on both sides of the vertical support.

18. The mulch film laying method according to claim 10, wherein
the walking mechanism comprises three pairs of vertical supports, two pairs of transverse connecting rods and six pairs of rollers; each pair of two vertical supports are arranged in parallel, the planes where each pair of vertical supports are located are parallel to each other, and three pairs of vertical supports are uniformly arranged front and back; the three vertical supports on each side are fixedly connected by an upper transverse connecting rod and a lower transverse connecting rod; the bottom ends of the pair of vertical supports at the head each are provided with a pair of head wheels, the bottom ends of the pair of vertical supports in the middle each are provided with a pair of middle wheels, and the bottom ends of the pair of vertical supports at the tail each are provided with a pair of tail wheels; and the head wheels and the tail wheels each are provided with the walking rotating motor for driving the wheels to rotate.

19. The mulch film laying method according to claim 10, wherein
a total of three pairs of reconfiguration mechanisms are provided, each pair of reconfiguration mechanisms comprises a pair of rotating motors, a pair of telescopic reconfiguration arms, and an electromagnet-iron block combination; the reconfiguration mechanisms are horizontally installed at the top ends of the vertical supports, respectively, and the two reconfiguration arms of each pair of reconfiguration mechanisms are arranged collinearly; the straight line where the reconfiguration arm is located is perpendicular to an advancing direction of the robot, the starting end of the reconfiguration arm is connected to the vertical support by the reconfiguration rotating motor, and the reconfiguration rotating motor is configured to drive the reconfiguration arm to lift upwards; and the tail ends of two reconfiguration arms are connected through the adsorption of the electromagnet and the iron block.

20. The mulch film laying method according to claim 19, wherein
the mulch film laying mechanism comprises two mulch film roller shafts, the mulch film laying mechanism is installed at the bottom ends of the pair of vertical supports in the middle, and the two mulch film roller shafts are alternately arranged front and back; the axis of each mulch film roller shaft is perpendicular to the advancing direction of the robot; the vertical support is connected to the mulch film roller shaft rotating motor by a universal joint coupling, and the mulch film roller shaft rotating motor is connected to the mulch film roller shaft and are configured to drive the mulch film roller shaft to rotate.
